(19) United States
(12) Patent Application Publication
(10) Pub. No.: US 2026/0234916 A1
(43) Pub. Date: Aug. 13, 2026

(54) FASTENING ARRANGEMENT FOR FASTENING TUBES TO A SANITARY FITTING

(71) Applicant: Neoperl GmbH, Müllheim (DE)

(72) Inventors: Werner KURY, Müllheim (DE); Marc TEMPEL, Freiburg (DE); Holger SCHÜRLE, Müllheim (DE)

(73) Assignee: Neoperl GmbH, Müllheim (DE)

(21) Appl. No.: 19/155,696

(22) PCT Filed: Aug. 18, 2023
(86) PCT No.: PCT/EP2024/072861

§ 371 Date: Aug. 12, 2025

(30) Foreign Application Priority Data
Feb. 24, 2023 (DE) 20 2023 100 891.7

(51) Int. Cl. E03C 1/04; F16L 37/14

(52) U.S. Cl. CPC E03C 1/0403; F16L 37/144; F16L 39/02

(57) ABSTRACT

Fastening arrangement for fastening hoses (6) to a sanitary fitting, having a base body (10) with two inflow openings (2) and one outflow opening (3) in each case for the insertion of a hose connector 5(4 ), are provided. The fastening arrangements include t a spring clip (12) that is guided around the outflow opening (3) and engages in the two inflow openings (2) from the outside in order to enable the securing to take place there.

### CROSS-REFERENCE TO RELATED APPLICATIONS

This application is a 371 National Phase of International Application No. PCT/EP2023/072861, filed Aug. 18, 2023, which claims priority from German Patent Application No. 20 2023 100 891.7, filed Feb. 24, 2023, both of which are incorporated herein by reference as if fully set forth.

### TECHNICAL FIELD

The invention relates to a fastening arrangement for fastening hoses to a sanitary fitting, having a base body with two inflow openings and one outflow opening in each case for the insertion of a hose connector.

### BACKGROUND

In the prior art, there are sanitary fittings in which the fluid connections are guided to the fitting, primarily to the valve of the sanitary fitting, via hoses. Fastening arrangements are known for fastening the hoses, which causes the hoses to be fixed in the plug-in direction. The fastening arrangement therefore essentially prevents the hose from being pushed out of its inflow or outflow opening by the water pressure.

### SUMMARY

The object of the invention is to provide an alternative fastening arrangement.

This object is achieved by a fastening arrangement having one or more of the features disclosed herein.

The fastening arrangement according to the invention is characterized in that a spring clip is guided around the outflow opening and engages at least in the two inflow openings from the outside in order to enable securing to take place there.

In this case, the spring clip grips onto the base body and engages in the hoses or hose connectors, which are axially secured, such that preloading of the spring clip on the hose connectors is not necessary. This can be achieved, for example, by virtue of the spring clip bearing with preload against the base body. The spring clip can also bear freely against the base body.

In one embodiment, the spring clip additionally also engages in the outflow opening from the outside transversely to the push-in direction of a hose connector. This can take place, for example, by virtue of the outflow opening having at least one opening in which the spring clip engages. This enables a hose connector to also be axially secured in the outflow opening. In particular, the outflow opening may be located substantially in the center of the spring clip. In addition, this enables the outflow hose to be fixed in a simple manner.

In one embodiment, the spring clip forms a substantially circular arc. This arc substantially creates a spring force, which is used to hold the spring clip in its position.

In one embodiment, more than half of the spring clip engages behind the inflow openings in its insertion direction, so that the spring clip generates a holding force.

In in alternative embodiment, more than half of the spring clip engages behind the outflow opening in its insertion direction, so that the spring clip generates a holding force or the outflow opening.

In the first variant, gripping is in this case provided radially from the outside, while in the second variant, the clip is guided slightly more tightly and thus does not engage directly from the outside, but instead from the side (along a secant).

Preferably, the spring clip engages in each case transversely to the push-in direction of a hose connector or in the radial direction in an opening of the inflow openings and/or outflow opening. This securely fixes the hose connector within the inflow opening and/or outflow opening.

In one embodiment, each end of the spring clip engages in a respective opening of the inflow openings and/or of the outflow opening. The spring clip extends through the opening and moreover engages in an inserted hose connector.

In one embodiment, the ends of the spring clip each have a bend that deviates from the circular shape, in particular wherein the bend engages in the opening of the inflow opening.

In one embodiment, an axial fixing means, for example having at least one fixing lug, for the spring clip is formed on the base body, said axial fixing means fixing the spring clip in the push-in direction of a hose connector. This makes it possible to prevent the spring clip from experiencing, in the region of the opening, a torque resulting from a movement, caused by the water pressure, of the hose connector. This relieves the load on the opening, as a result of which any damage to the base body can be prevented.

The axial fixing means can be formed in various ways. The axial fixing means can preferably be arranged on the outside of the outflow opening.

The axial fixing means may be formed by at least two fixing lugs, which are axially spaced apart from one another and between which the spring clip is located in the use position, wherein the axial spacing between the fixing lugs preferably substantially corresponds to the axial extent of the spring clip. This prevents axial movement of the spring clip.

The two fixing lugs may be arranged so as to be offset relative to one another in the circumferential direction of the outflow opening, as a result of which the effective bearing surface area is increased.

An axial fixing means may also be formed by a groove in which the spring clip engages in the use position. The groove is preferably formed on the outflow opening and oriented in the tangential direction.

So that the spring clip can create a spring force, it is expedient if it consists of an elastic material, preferably a spring-elastic material. It is particularly expedient if the spring clip consists of metal or plastic.

In one embodiment, the base body has an interface for connecting to a valve cartridge or in that the base body is integrally formed on a valve cartridge. As a result, the fastening arrangement according to the invention can be used in a variety of ways and is also suitable for replacing existing fittings.

### BRIEF DESCRIPTION OF THE DRAWINGS

The invention is explained in more detail below on the basis of exemplary embodiments with reference to the appended drawings, in which:

FIG. 1 shows a longitudinal section through a first embodiment of a fastening arrangement, with hoses inserted,

FIG. 2 shows an oblique view of the fastening arrangement in FIG. 1,

FIG. 3 shows a cross section through the oblique view in FIG. 1,

FIG. 4 shows an oblique view of a second embodiment of a fastening arrangement,

FIG. 5 shows a cross section through the oblique view in FIG. 4,

FIG. 6 shows a side view of the fastening arrangement in FIG. 4,

FIG. 7 shows a cross section of the fastening arrangement in FIG. 4,

FIG. 8 shows a cross section of the fastening arrangement in FIG. 2,

FIG. 9 shows a cross section of an alternative fastening arrangement similar to FIG. 2,

FIG. 10 shows an oblique view of a third embodiment of a fastening arrangement,

FIG. 11 shows a cross section through the fastening arrangement in FIG. 10,

FIG. 12 shows a cross section of the oblique view in FIG. 10, and

FIG. 13 shows a detail of the fastening arrangement in FIG. 10 without a spring clip.

### DETAILED DESCRIPTION

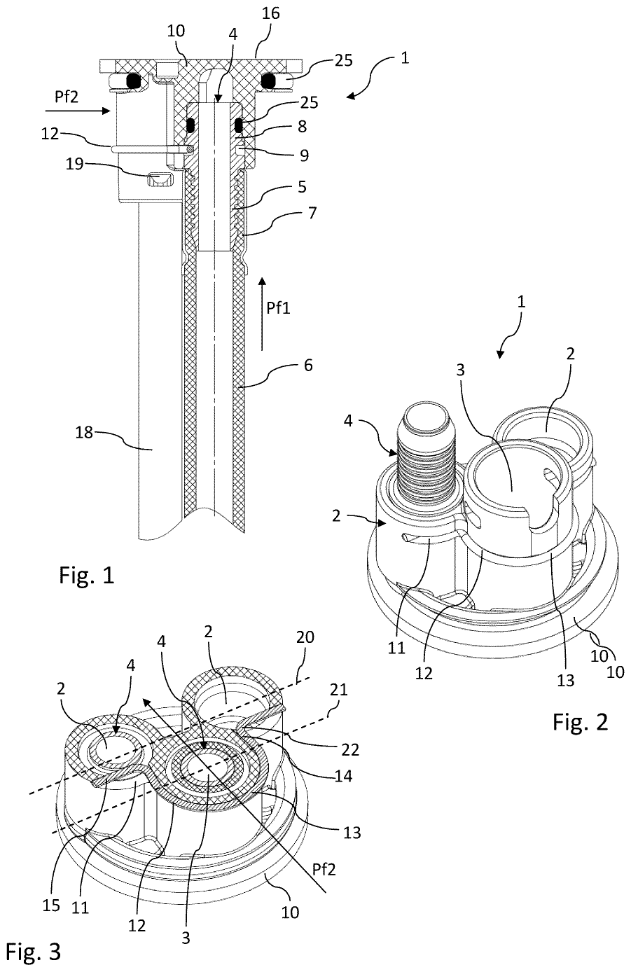

FIGS. 1 to 3 show a first embodiment of a fastening arrangement 1 according to the invention. The fastening arrangement 1 has a base body 10 with two inflow openings 2 and one outflow opening 3. An O-ring 25 for radially sealing the fastening arrangement 1 is arranged on the base body 10.

In the example, the outflow opening 3 is designed to be longer than the inflow openings 2 in the axial direction. However, this is not important for the invention.

The inflow openings 2 are designed so that in each case a hose connector 4 can be inserted therein.

A hose connector 4 has a plug-on part 5, onto which a hose 6 can be plugged and to which the hose 6 is fastened using a crimp connector 7. The hose connector 4 has, axially from the plug-on part 5, a push-in part 8, which can be inserted into an inflow opening 2. On this push-in part 8, an O-ring 25 is inserted into a circumferential groove as a radial seal in relation to the inflow opening 2.

In the example, the push-in part 8 has a further circumferential groove 9, which in the example is located further away from the push-in end of the push-in part 8 than the O-ring 25, i.e. located closer to the plug-on part 5 than the O-ring 25, in the axial direction. The base body 10 has, at the inflow openings 2, in each case an opening 11, which corresponds, in the axial direction, to the position of the circumferential groove 9 of a hose connector 4.

In order to fasten the hose 6 within the inflow opening, provision is made for a spring clip 12, which engages through the opening 11 into the groove 9. As a result, the hose connector 4 is fixed within the inflow opening 2 in the hose insertion direction Pf1.

In this embodiment, the openings 11 in the inflow openings 2 are approximately parallel to a connecting line 20 through the centers of the two inflow openings 2.

The spring clip 12 is guided around the outside of the outflow opening 3 and forms an arc 13. The arc 13 extends from the spring clip insertion direction Pf2 around the center 21 of the outflow opening 3, so that the arc 13 engages behind the outflow opening 3 and narrows behind the outflow opening 3, so that a narrowing 22 is formed. The spring clip 12 thus clasps the outflow opening 3 and as a result creates a holding force, which fixes the spring clip 12 in its insertion direction Pf2, on the outflow opening 3. At each of its ends, the arc 13 has bends 14, which each angle the spring clip outwards by approximately 90°. These bent ends 15 engage in the openings 11 and in the grooves 9 of the hose connectors 4 in the spring clip insertion direction Pf2.

In another exemplary embodiment, the spring clip 12 is shaped such that, in its use position, it engages in the outflow opening 3 from the outside in order to axially secure a hose connector 4 that is inserted therein.

The fastening arrangement 1 according to FIGS. 1 to 3 has, at the free end, an interface 16, for instance a flange, for connecting to a valve cartridge or a fitting. The connection to a valve cartridge takes place, for instance, within a fitting by axial clamping by means of a screw connection or in another known way.

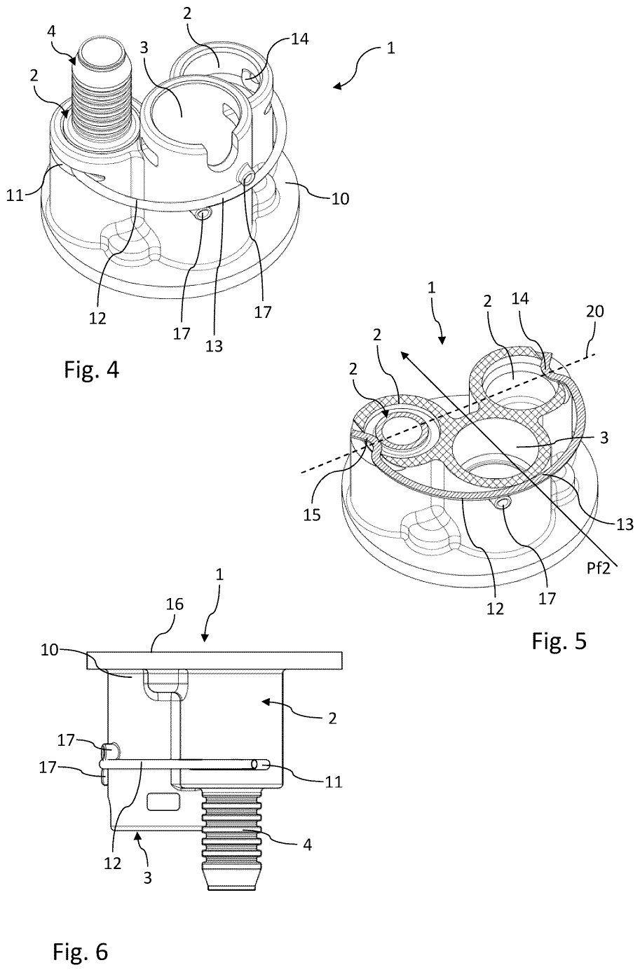

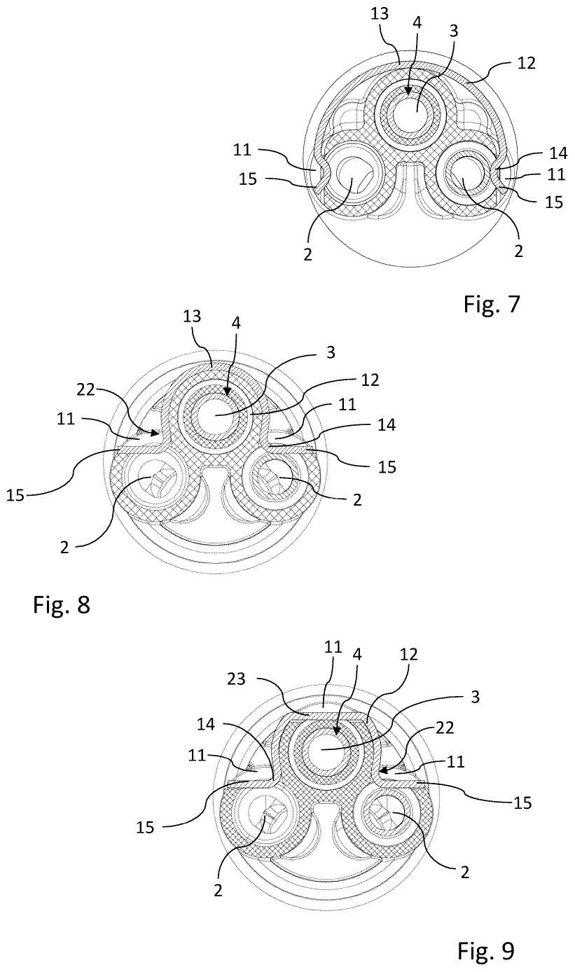

FIGS. 4 to 7 show an alternative embodiment of a fastening arrangement 1. In this case, identical features are provided with the same reference signs and are not described again separately.

The difference from the embodiment in FIGS. 1 to 3 is that the openings 11 in the inflow openings are now each located radially on the outside of the inflow openings 2 in the region of a connecting line 20 through the centers of the inflow openings 2.

In this case, the spring clip forms a slightly larger arc 13, which extends from the spring clip insertion direction Pf2 around the center of the inflow openings 3, so that the arc 13 engages behind the inflow openings 3. In this case, bends 14, which are directed radially inwards from the arc 13, are formed at the ends of the arc 13. In this case, too, the bent ends 15 engage in the openings 11 of the inflow openings 2 from the outside.

In this embodiment, the spring clip 12 is fixed in its insertion direction Pf2 by engaging in the openings 11.

In order to axially fix the spring clip 13 on the fastening arrangement 1, two fixing lugs 17 are arranged in this case on the outer circumference of the outflow opening 3 and are axially spaced apart from one another such that the spring clip 13 runs through between the fixing lugs 17.

In the examples shown, specifically a latching connection 19 is provided for axially fixing the outflow hose 18.

In both embodiments, however, it would also be conceivable for an opening, in which the spring clip 13 engages in order to engage in a hose connector of the outflow opening, also to be present at the outflow opening 3.

FIGS. 8 and 9 each show a two-dimensional sectional representation in the transverse plane of a fastening arrangement 1 according to the invention according to FIGS. 1 to 3.

FIG. 8 shows how the spring clip 12 is guided from the outside around the outflow opening 3 and forms an arc 13. The arc 13 engages behind the outflow opening 3 and narrows to form a narrowing 22 behind the outflow opening 3. The spring clip 12 thus clasps the outflow opening 3 and as a result creates a holding force on the outflow opening 3.

FIG. 8 shows another exemplary embodiment of the fastening arrangement 1. In this example, instead of the arc, the spring clip 12 has a secant piece 23, which, in its use position, engages in the outflow opening 3 from the outside in order to axially secure a hose connector 4, which is inserted therein. For this purpose, in the example, the outflow opening 3 has a tangential opening 11, in which the secant piece 23 of the spring clip 12 additionally engages. At the same time, the spring clip 12 is axially secured as a result.

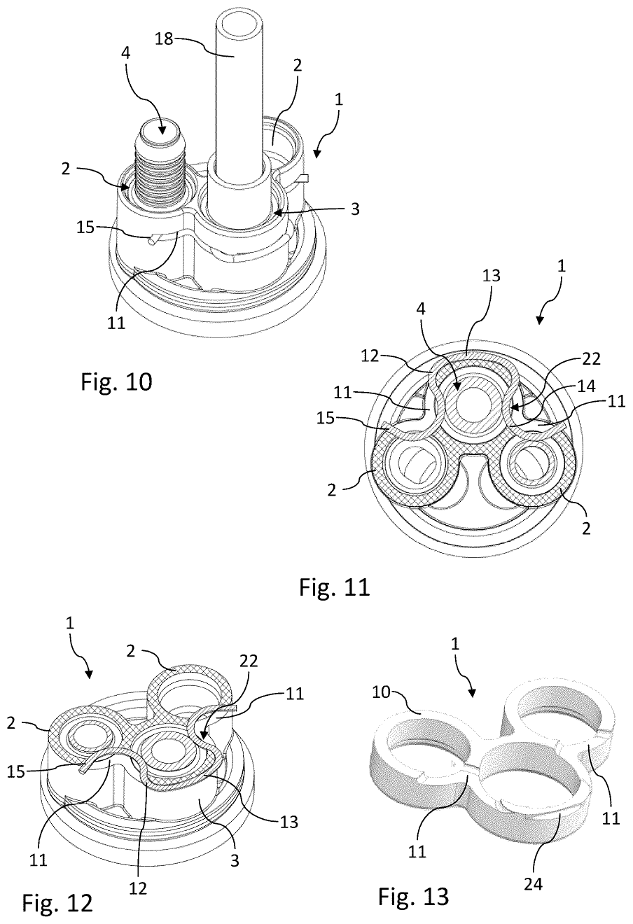

FIGS. 10 to 13 show a further embodiment of a fastening arrangement 1, similar to the embodiment in FIGS. 1 to 3. In this embodiment, the outflow opening 3 additionally has two openings 11, which in the example in each case coincide with one of the openings 11 in the inflow openings 2. This secures the hose connectors 4 both in the inflow openings 2 and in the outflow opening 3. The spring clip 12 has a larger bend 14, so that the spring clip 12 also engages in the outflow opening 3. In this case, similarly to the embodiment in FIGS. 8 and 9, the spring clip 12 forms a narrowing 22, which fixes the spring clip 12 in the radial direction.

In addition, the fastening arrangement 1 has a tangential groove 24 at the outflow opening 3. The spring clip 12, or more precisely its flattened arc 13, engages in this groove 24 in the use position, as a result of which the spring clip 12 is also axially secured.

### LIST OF REFERENCE SIGNS

1 Fastening arrangement
2 Inflow openings
3 Outflow opening
4 Hose connector
5 Plug-on part
6 Inflow hose
7 Crimp connector
8 Push-in part
9 Circumferential groove
10 Base body
11 Opening
12 Spring clip
13 Arc
14 Bend
15 Bent end
16 Interface
17 Fixing lug
18 Outflow hose
19 Latching connection
20 Connecting line through the midpoints of the inflow openings
21 Center of the outflow opening
22 Narrowing
23 Secant piece
24 Groove
25 O-ring
Pf1 Hose insertion direction
Pf2 Spring clip insertion direction

1. A fastening arrangement for fastening hoses (6) to a sanitary fitting, the arrangement comprising:
a base body (10) with two inflow openings (2) and one outflow opening (3) in each case for insertion of a hose connector (4);
a spring clip (12) that is guided around the outflow opening (3) and engages at least in the two inflow openings (2) from outside in order to secure the hose connectors (4) once inserted in the two inflow openings (2).

2. The fastening arrangement as claimed in claim 1, wherein the outflow opening (3) is located substantially in a center of the spring clip (12) and/or the spring clip (12) additionally engages in the outflow opening (3) from outside in order to secure the hose connector (4) once inserted in the outflow opening (3).

3. The fastening arrangement as claimed in claim 1, wherein the spring clip (12) forms a substantially circular arc (13).

4. The fastening arrangement as claimed in claim 1, wherein more than half of the spring clip (12) engages behind the inflow openings (2) or the outflow opening (3) in an insertion direction (Pf2), so that the spring clip (12) generates a holding

5. The fastening arrangement as claimed in claim 1, further comprising a respective opening (11) defined in the base body (10) that intersect a respective ones of the inflow openings (2) and/or the outflow opening (3), and the spring clip (12) engages in the openings (11) that intersect the inflow openings (2) and/or the opening that intersects the outflow opening (3) in each case transversely to a push-in direction (Pf1) of the hose connectors (4) or in a radial direction.

6. The fastening arrangement as claimed in claim 5, wherein each end (15) of the spring clip (12) engages in a respective one of the openings (11) that intersect the inflow openings (2) and/or the outflow opening (3).

7. The fastening arrangement as claimed in claim 6, wherein the ends (15) of the spring clip (12) each have a bend (14) that deviates from a circular shape, and the bends (14) engage in respective ones of the openings (11) that intersect the inflow opening (2) and/or the outflow opening (3).

8. The fastening arrangement as claimed in claim 1, further comprising an axial fixing means for the spring clip (12) formed on the base body (10), said axial fixing means axially fixing the spring clip (12) in a push-in direction (Pf1) of the hose connector (4).

9. The fastening arrangement as claimed in claim 8, wherein the axial fixing means is arranged on an outside of the outflow opening (3).

10. The fastening arrangement as claimed in claim 1. wherein the spring clip (12) consists of metal or plastic.

11. The fastening arrangement as claimed in claim 1, wherein the base body (10) includes an interface (16) for connecting to a valve cartridge or the base body (10) is integrally formed on a valve cartridge.

12. The fastening arrangement as claimed in claim 8, wherein the axial fixing means is formed by at least two fixing lugs (17), which are axially spaced apart by an axial spacing from one another and between which the spring clip (12) is located in a use position, and the axial spacing between the fixing lugs (17) substantially corresponds to an axial extent of the spring clip (12).

13. The fastening arrangement as claimed in claim 12, wherein the two fixing lugs (17) are arranged offset relative to one another in a circumferential direction of the outflow opening (3).

14. The fastening arrangement as claimed in claim 8, wherein the axial fixing means is formed by a groove (23) in which the spring clip (12) engages in a use position.
